(19) United States
(12) Patent Application Publication
(10) Pub. No.: US 2008/0293269 A1
(43) Pub. Date: Nov. 27, 2008

(54) ELECTRIC CONNECTION BOX

(75) Inventors: Ayumu KURIZONO, Kakegawa-shi (JP); Naoki NAGAUSHI, Kakegawa-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 11/848,345

(22) Filed: Aug. 31, 2007

(30) Foreign Application Priority Data
Aug. 31, 2006 (JP) 2006-235758

(51) Int. Cl. H01R 9/24

(52) U.S. Cl. 439/76.2

(57) ABSTRACT

An electric connection box includes a main body which receives a parts connected to a wire, a lower cover which is attached to the main body to cover a lower face of the main body, a first notch which is formed in the lower cover, a second notch which is formed in the lower cover in continuous with the first notch, a lid which opens and closes the second notch, peripheral walls which are formed respectively at the lower cover and the lid, and define the first notch as art opening when the lid is closed, and ridge portions which are formed respectively on inner surfaces of the peripheral walls of the lower cover and the lid, and are fitted in an annular concave portion in an outer periphery of a wire protection tube fitted on the wire led out through the first notch when the lid is closed.

### BACKGROUND OF THE INVENTION

This invention relates to an electric connection box (i.e., an electric junction box, or an electric distribution box) such as a relay box, a fuse box or the like for mounting on a vehicle such as an automobile.

When wires are to be led out through a wire lead-out hole formed in an outer wall of an electric connection box, relatively, a corrugated tube (wire protection tubs) is fitted on the wires for the purpose of protecting the wires and also for waterproof purposes, and a waterproof structure having a convex/concave fitting arrangement is provided between the corrugated tube and the wire lead-out hole.

FIG. 24 is a vertical cross-sectional view of an electric connection box described in Patent Literature 1. This electric connection box 100 includes a connection box body 101, an upper cover 102 fitted on the upper side of the connection box body 101, and a lower cover 103 fitted on the lower side of the connection box body 101. The electric connection box has a wire lead-out portion 105 of a cylindrical shape provided at a plane of junction between the connection box body 101 and the lower cover 103. This wire lead-out portion 105 includes a lower semi-cylindrical portion and an upper semi-cylindrical portion 105B which are joined together to form the wire lead-out portion 105 of a cylindrical shape. Annular convex and concave portions 106a and 106b are formed on an inner periphery of the wire lead-out portion 105, and are fitted to annular concave and convex portions Ca and Cb formed on an outer periphery of a corrugated tube C fitted on wires W.

For fixing the corrugated tube C (fitted on the wires W) to the electric connection box 100, the corrugated tube C is positioned relative to the wire lead-out portion 105 simultaneously when the lower cover 103 is attached to the lower side of the connection box body 101, and the convex and concave portions 106a and 106b on the inner periphery of the wire lead-out portion 105 are fitted to the concave and convex portions Ca and Cb. By doing so, water is less liable to pass through the concave/convex fitting portions, so that a waterproof performance is secured.

[Patent Literature 1] JP-A-9-327111

In the electric connection box 100 shown in FIG. 24, the corrugated tube C is positioned relative to the electric connection box 100 simultaneously when the lower cover 103 is attached to the connection box body 101. Therefore, the lower cover 103 must be attached to the connection box body 101 while beforehand deciding the fixing position of the corrugated tube C, and this assembling operation must be carried out while directing attention to both of the corrugated tube and the lower cover, and therefore the assembling operation has been cumbersome. Furthermore, when it is desired to amend the position of the corrugated tube C after the lower cover 103 is attached to the connection box body 101, the lower cover 103 must be again detached from the connection box body 101, and in this respect, also, the operation has been cumbersome.

### SUMMARY OF THE INVENTION

This invention has been made in view of the above circumstances, and an object of the invention is to provide an electric connection box in which a mounting position of a corrugated tube (wire protection tube) can be adjusted in an attached condition of a lower cover, and an assembling operation as well as the adjustment at a later stage can be easily carried out.

The above object has been achieved by an electric connection box of the present inventions having features recited in the following Paragraphs (1) to (5).

(1) An electric connection box includes:

a main body for receiving a part to be connected to a wire;

a lower cover attached to the main body to cover a lower face of the main body;

a first notch for wire lead-out purposes formed in the lower cover;

a second notch which is formed in the lower cover in continuous with the first notch so that the wires can be inserted into the first notch from the side of the lower cover through the second notch;

a lid for opening and closing the second notch;

peripheral walls which are formed respectively at the lower cover and the lid, and define the first notch as an opening when the lid is closed; and

ridges which are formed respectively on inner surfaces of the peripheral walls of the lower cover and the lid, and are fitted in an annular concave portion in an outer periphery of a wire protection tube fitted on the wires led out through the first notch when the lid is closed.

(2) in the electric connection box of the above Paragraph (1), the main body, the lower cover and the lid are resin-molded products, and the lid is molded integrally with one of the main body and the lower cover through a hinge portion so as to be pivotally moved
(3) in the electric connection box of the above Paragraph (2), the lid is pivotally connected to a lower edge of an outer wall of the main body through the hinge portion so as to be pivotally moved upward and downward.

(4) in the electric connection box of the above Paragraph (2), the lid is pivotally connected to a side edge of the second notch in the lower cover so as to be pivotally moved right and left.

(5) in the electric connection box of any one of the above Paragraphs (1) to (4), abutment walls are formed respectively at peripheral edges of the second notch and the lid, and abut against each other to close a gap therebetween when the fid is closed, and engagement portions are formed respectively at the lower cover and the lid, and are engaged with each other to lock the lower cover and the lid to each other when the lid is closed.

In the electric connection box of the above Paragraph (1), after the lower cover is attached to the main body, the position of the wire protection tube is adjusted, and then the lid is closed, so that the ridges formed respectively on the inner surfaces of the peripheral walls of the lower cover and the lid are fitted into the annular concave portion in the outer periphery of the wire protection tube. Therefore, the wire protection tube can be positioned and fixed. Thus, the position of the tube can be adjusted after the lower cover is attached to the main body, and therefore the assembling operation can be easily carried out. Furthermore, merely by opening the lid with the lower cover kept attached to the main body, the fixing of the wire protection tube is canceled, and therefore the disassembling operation can also be easily carried out, and besides the position of the wire protection tube can again be easily adjusted.

In the electric connection box of the above Paragraph (2), the lid is not formed separately from the main body or the lower cover, but is molded integrally with the main body or the lower cover through the hinge portion. Therefore, the number of the component parts is reduced, and besides merely by pivotally moving the lid through the hinge portion, the lid can be easily closed into the proper position, and the efficiency of the assembling operation can be enhanced.

In the electric connection box of the above Paragraph (3), the lid is molded integrally with the main body, and therefore the construction of the lower cover can be simplified.

In the electric connection box of the above Paragraph (4), the lid is molded integrally with the lower cover, and therefore the construction of the main body can be simplified.

In the electric connection box of the above Paragraph (5), by closing the lid, a sealing effect can be secured, and besides the id can be positively fixed without shaking.

In the present invention, there can be provided the electric connection box in which the mounting position of the corrugated tube (wire protection tube) can be adjusted in the attached condition of the lower cover, and the assembling operation as well as the adjustment at a later stage can be easily carried out.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view of a connection box body (a main body) of a first embodiment of an electric connection box of the present invention as seen from the lower side;

FIG. 2 is a perspective view as seen from the lower side, showing a condition in which a lower cover is about to be attached to the connection box body;

FIG. 3 is a perspective view as seen from the lower side, showing a condition in which the lower cover is attached to the connection box body;

FIG. 4 is a perspective view as seen from the lower side, showing a condition in which a corrugated tube is about to be attached to the lower cover attached to the connection box body;

FIG. 5 is a perspective view as seen from the upper side, showing the condition of FIG. 4;

FIG. 6 is a perspective view as seen from the lower side, showing a condition in which the corrugated tube is attached to the lower cover;

FIG. 7 is a perspective view as seen from the upper side, showing the condition of FIG. 6;

FIG. 8 is a perspective view as seen from the lower side, showing a condition in which a lid is about to be closed after the corrugated tube is attached to the lower cover;

FIG. 9 is a perspective view as seen from the upper side, showing the condition of FIG. 8;

FIG. 10 is a perspective view as seen from the lower side, showing a condition in which the lid is closed;

FIG. 11 is a perspective view as seen from the upper side, showing the condition of FIG. 10;

FIG. 12 is a perspective view of a connection box body of a second embodiment of an electric connection box of the present invention as seen from the lower side;

FIG. 13 is a perspective view as seen from the lower side, showing a condition in which a lower cover is about to be attached to the connection box body;

FIG. 14 is a perspective view as seen from the lower side, showing a condition in which the lower cover is attached to the connection box body;

FIG. 15 is a perspective view as seen from the lower side, showing a condition in which a corrugated tube is about to be attached to the lower cover attached to the connection box body;

FIG. 16 is a perspective view as seen from the upper side, showing the condition of FIG. 15;

FIG. 17 is a perspective view as seen from the lower side, showing a condition in which the corrugated tube is further moved upward;

FIG. 18 is a perspective view as seen from the lower side, showing a condition in which the corrugated tube is attached to the lower cover;

FIG. 19 is a perspective view as seen from the upper side, showing the condition of FIG. 16;

FIG. 20 is a perspective view as seen from the lower side, showing a condition in which a lid is about to be closed after the corrugated tube is attached to the lower cover;

FIG. 21 is a perspective view as seen from the upper side, showing the condition of FIG. 20;

FIG. 22 is a perspective view as seen from the lower side, showing a condition in which the lid is closed;

FIG. 23 is a perspective view as seen from the upper side, showing the condition of FIG. 22; and

FIG. 24 is a cross-section at view of a related example.

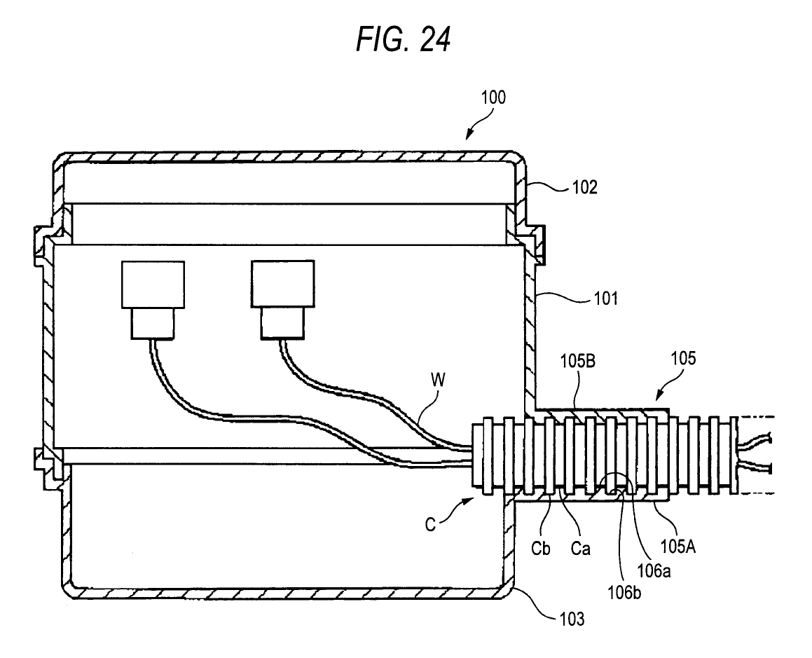

The present invention has been briefly described above. Details of the invention will become more manifest upon reading the following Section “Detailed Description of the Preferred Embodiments” with reference to the accompanying drawings.

### DETAILED DESCRIPTION OF THE PREFERRED EMBODIMENTS

Preferred embodiments of the present invention will now be described in detail with reference to the drawings.

### First Embodiment

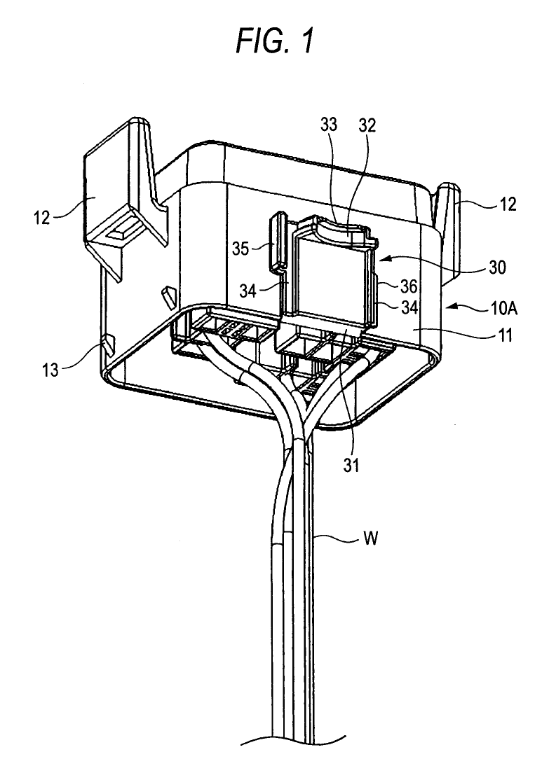

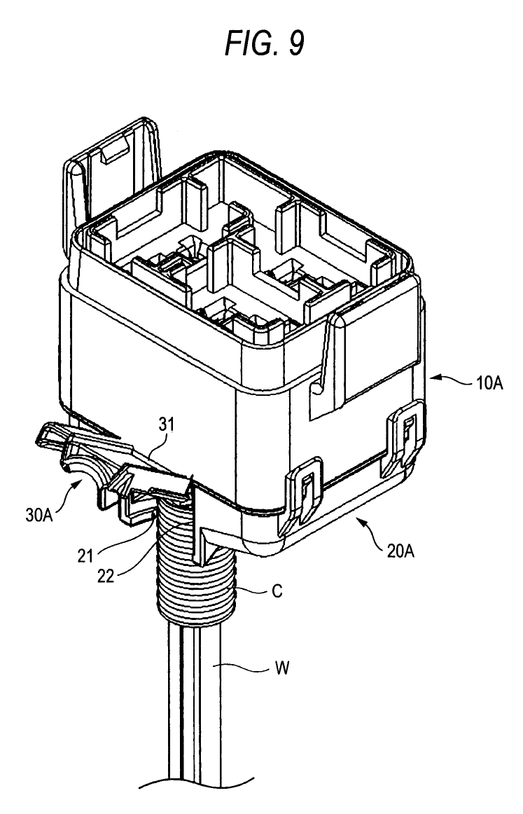

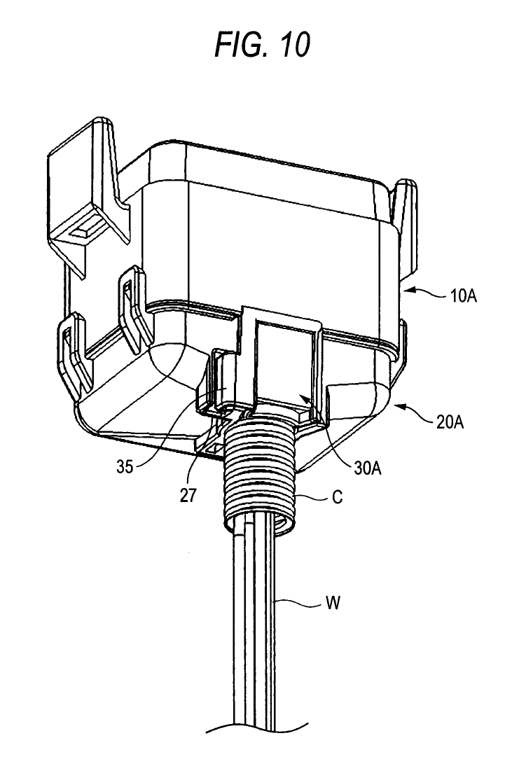

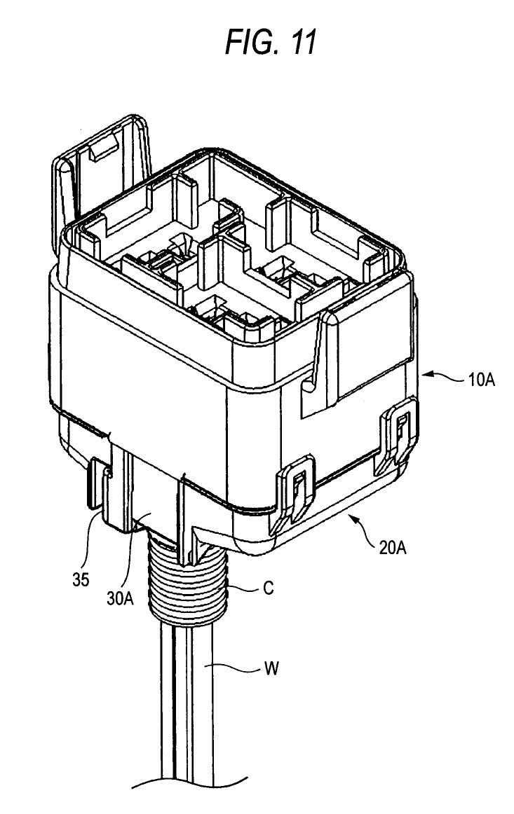

FIGS. 1 to 11 show the construction of an electric connection box of the first embodiment. This electric connection box includes a connection box body 10A for receiving parts (such as relays and so on) connected to wires W, a lower cover 20A attached to the connection box body 10A to cover a lower side of this connection box body 10A, and an upper cover (not shown) attached to the connection box body 10A to cover an upper side of this connection box boy 10A. Engagement portions 12 for locking engagement with the upper cover are formed on an outer wall (side wall) 11 of the connection box body 10A. Also, engagement portions (projections in the illustrated embodiment) 13 for locking engagement respectively with engagement portions (frame-like engagement portions in the illustrated embodiment) 23 on the lower cover 20A are formed on the outer wall 11.

A first notch 21 for wire lead-out purposes is formed in a bottom wall 20a of the lower cover 20A. A second notch 22 is formed in a side wall 20b of the lower cover 20A in continuous relation to the first notch 21, and extends from an upper edge of the side wait 20b to the bottom wall 20a so that the wires W can be inserted into the first notch 21 from the side through the second notch 22.

A lid 30A for opening and closing the second notch 22 in the lower cover 20A is pivotally connected through a hinge (hinge portion) 31 to a lower edge of the outer wall 11 of the connection box body 10A so as to be pivotally moved upward and downward. Therefore, the connection box body 10A and the lid 30A are molded into an integral construction, using a synthetic resin, and therefore are provided in the form of a one-piece resin-molded product. The lower cover 20A is a resin-molded product separate from the resin-molded product forming the connection box body 10A and the lid 30A. Thus, the electric connection box includes the two molded parts.

A peripheral wall 24 is formed at a peripheral edge of the first notch 21 in the lower cover 20A, and a peripheral wall 32 is formed on an inner surface of the lid 30A at one end thereof remote from the hinge 31. When the lid 30A is closed, the peripheral walls 24 and 32 cooperate with each other to define the first notch 21 as an opening closed over an entire periphery thereof. A ridge 25 is formed on an inner surface of the peripheral wall 24, and a ridge 33 is formed on an inner surface of the peripheral wall 32. When the lid 30A is closed, the ridges 25 and 33 are fitted in an annular concave portion Ca in an outer periphery of a corrugated tube (wire protection tube) C fitted on the wires W led out through the first notch 21. Annular concave portions Ca and annular convex portions Cb are arranged alternately at the outer periphery of the corrugated tube C.

An abutment wall 26 is formed at a peripheral edge of the second notch 22, and an abutment wall 34 is formed at a peripheral edge of the lid 30A. When the lid 30A is closed, the abutment walls 26 and 34 abut against each other to close a gap therebetween. Further, engagement portions 27 and 26 are formed at the lower cover 20A, and engagement portions 35 and 36 are formed at the lid 30A. When the lid 30A is closed, the engagement portions 27 and 28 are engaged respectively with the engagement portions 35 and 36 to thereby lock the lid 30A and the lower cover 20A to each other. The engagement portions 35 and 36 are formed respectively at the left and right side edges of the fid 30A, and the engagement portions 27 and 28 are formed at those portions of the lower cover 20A corresponding respectively to the engagement portions 35 and 36.

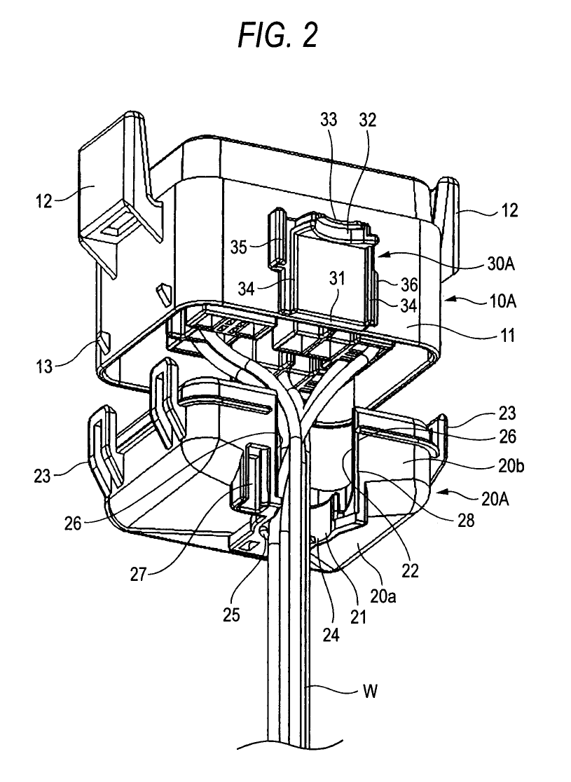

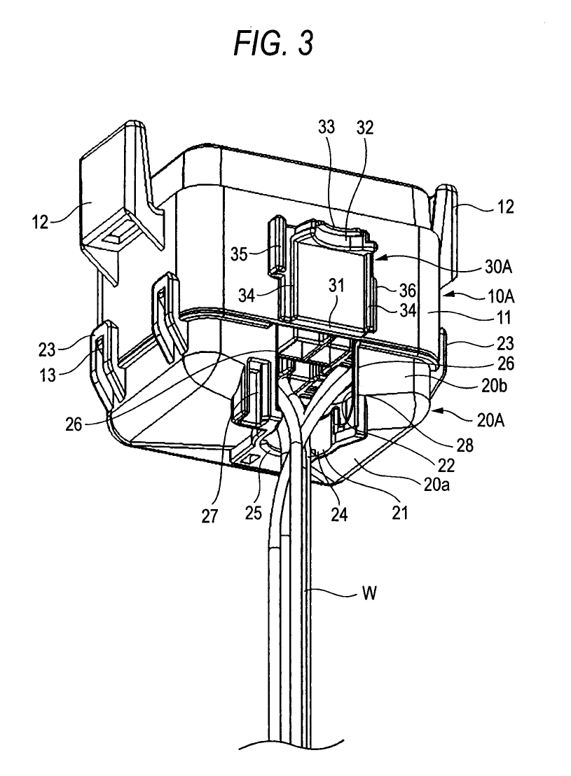

For assembling this electric connection box, the lower cover 20A is attached to the lower side of the connection box body 10A as shown in FIGS. 2 and 3. At this time, the wires W are inserted into the first notch 21 from the second notch 22. At this stage, the lid 30A is held in the open (upper) position so as not to interfere with the operation for attaching the lower cover 20A.

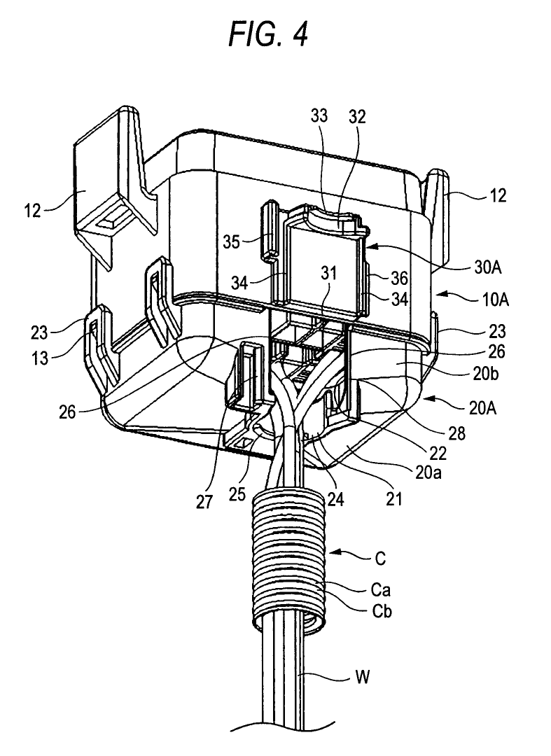

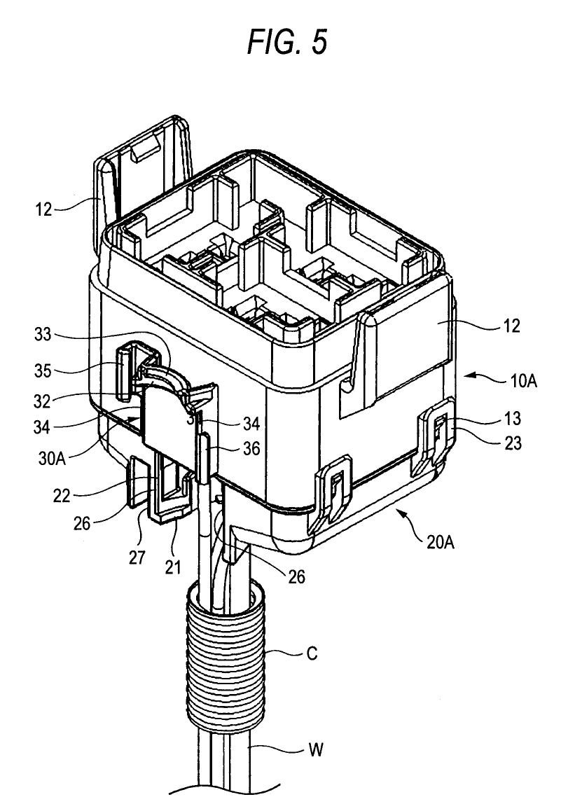

Then, the corrugated tube C is fitted on the wires W as shown in FIGS. 4 and 5. Usually, a longitudinal slit (not shown) is formed in the corrugated tube C, and therefore the longitudinal silt is opened, and in this condition the wires W are received in the corrugated tube C.

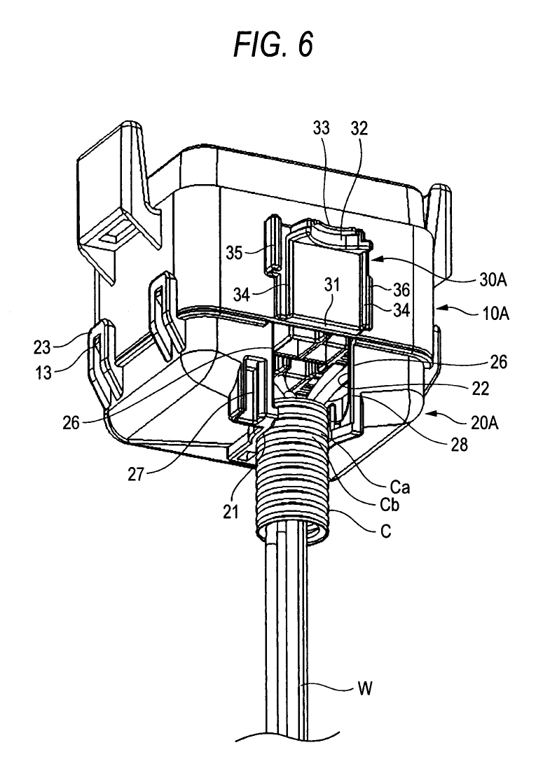

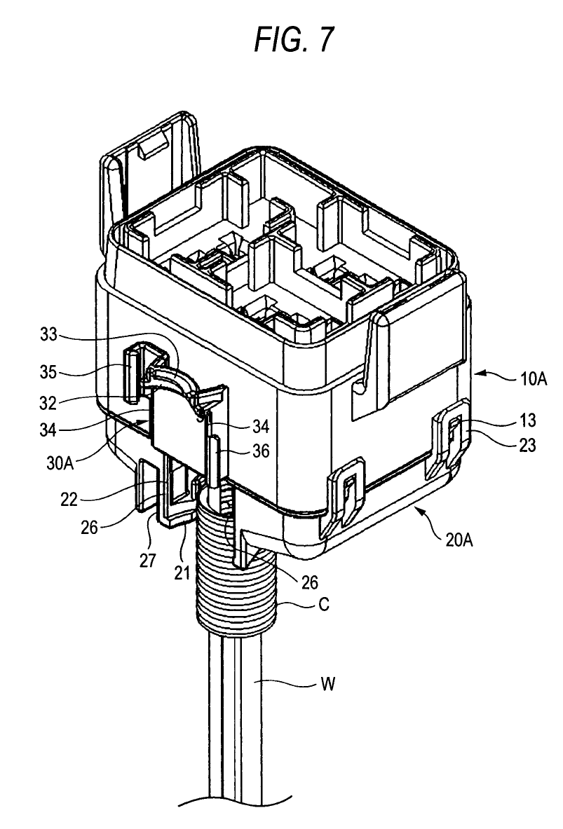

Then, as shown in FIGS. 6 and 7, the position of the corrugated tube C is adjusted, and a fixing portion of the corrugated tube C is located at the ridge 25 (see FIGS. 3 and 4) of the first notch 21.

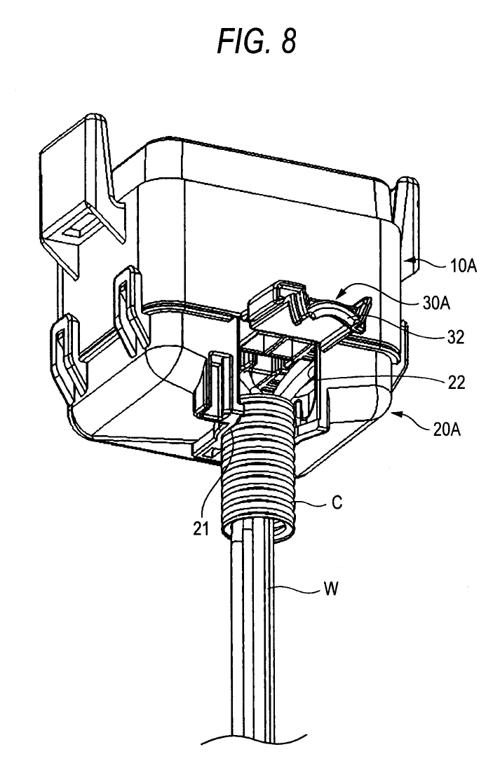

In this condition, the lid 30A is closed as shown in FIGS. 8 to 11. As a result, the ridges 25 and 33 formed respectively on the inner surfaces of the peripheral walls 24 and 32 of the lower cover 20A and the lid 30A are fitted in the annular concave portion Ca in the outer periphery of the corrugated tube C, thereby positioning and fixing this wire protection tube C.

Thus, after the tower cover 20A is attached to the connection box body 10A, the position of the corrugated tube C is adjusted, and then the lid 30A is closed, and by doing so, the corrugated tube C can be positioned and fixed. Therefore, the assembling operation can be easily carried out. Furthermore, merely by opening the lid 30A with the lower cover 20A kept attached to the connection box body 10A, the fixing of the corrugated tube C is canceled, and therefore the disassembling operation can also be easily carried out, and besides the position of the corrugated tube C can again be easily adjusted.

Furthermore, when the lid 30A is closed, the abutment walls 26 and 34 abut against each other, and also the engagement portions 35 and 36 are engaged respectively with the engagement portions 27 and 28, and therefore a sealing effect can be secured, and besides the lid 30A can be positively fixed without shaking.

Furthermore, in this embodiment, the lid 30A is molded integrally with the connection box body 10A through the hinge 31, and therefore the number of the component parts can be reduced, and besides merely by pivotally moving the lid 30A through the hinge 31, the lid 30A can be easily closed into the proper position, and the efficiency of the assembling operation can be enhanced. Furthermore, by thus molding the lid 30A integrally with the connection box body 10A, the construction of the lower cover 20A can be simplified.

### Second Embodiment

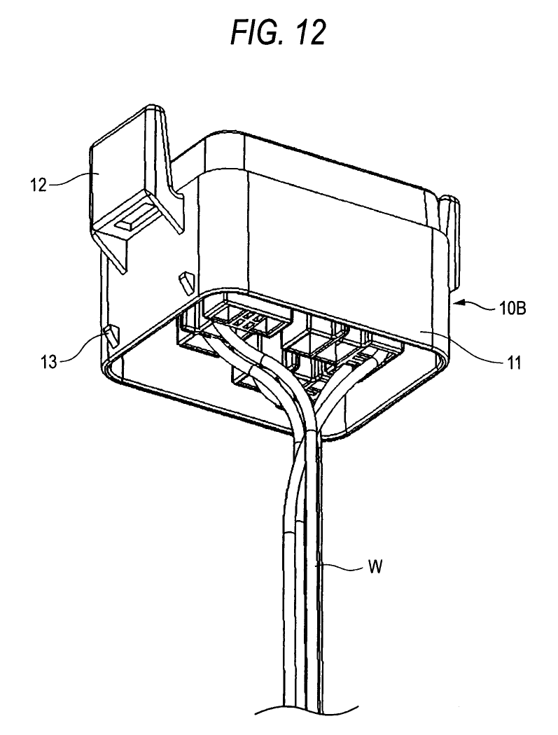

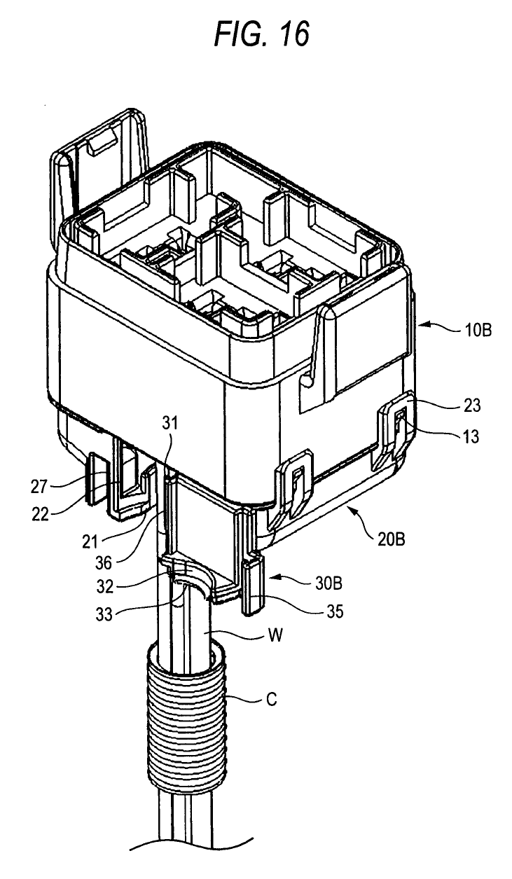

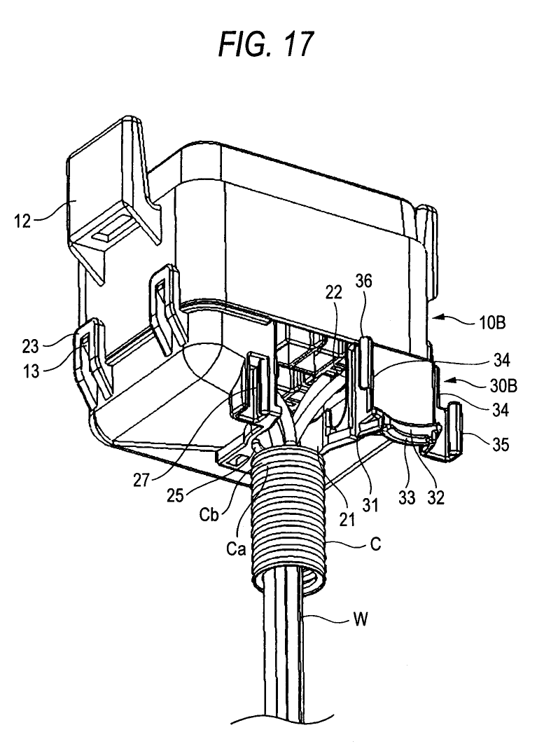

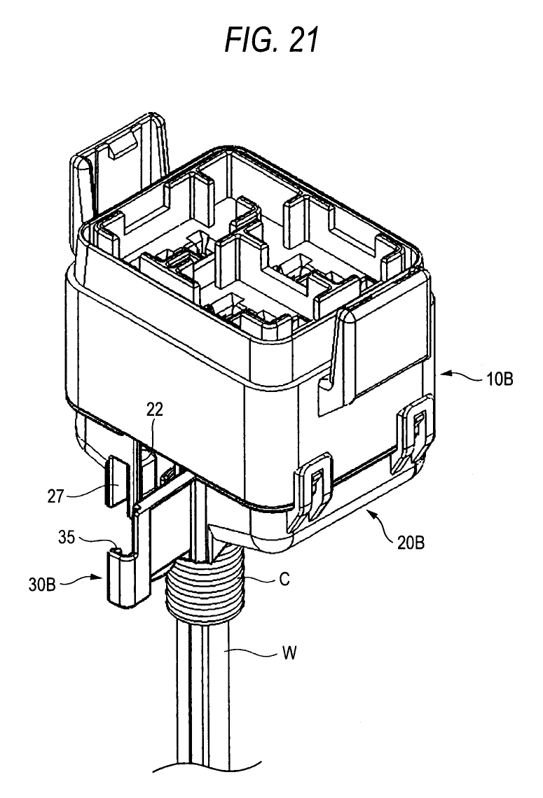

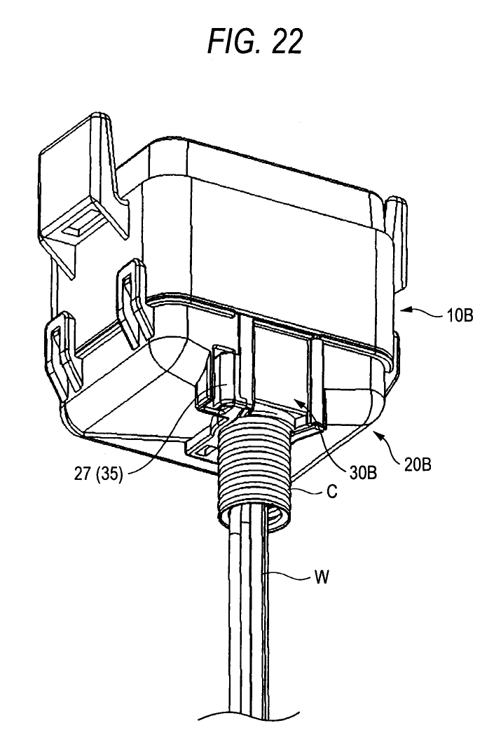

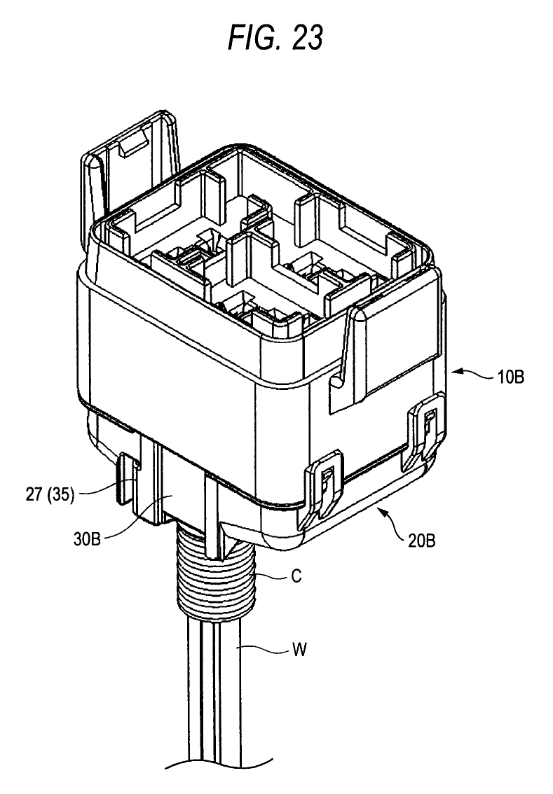

FIGS. 12 to 23 show the construction of an electric connection box of the second embodiment.

The electric connection box of the second embodiment differs from the electric connection box of the first embodiment only in that a lid 30B is integrally connected not to a connection box body 10B but to a lower cover 20B. Therefore, identical constituent elements will be designated by identical reference numerals, respectively, and description thereof will be omitted.

Namely, in the electric connection box of the second embodiment, the lid 30B is pivotally connected to a side edge of a second notch 22 in the lower cover 20B through a hinge (hinge portion) 31 so as to be pivotally moved right and left, and thus the lid 30B is molded integrally with the lower cover 20B.

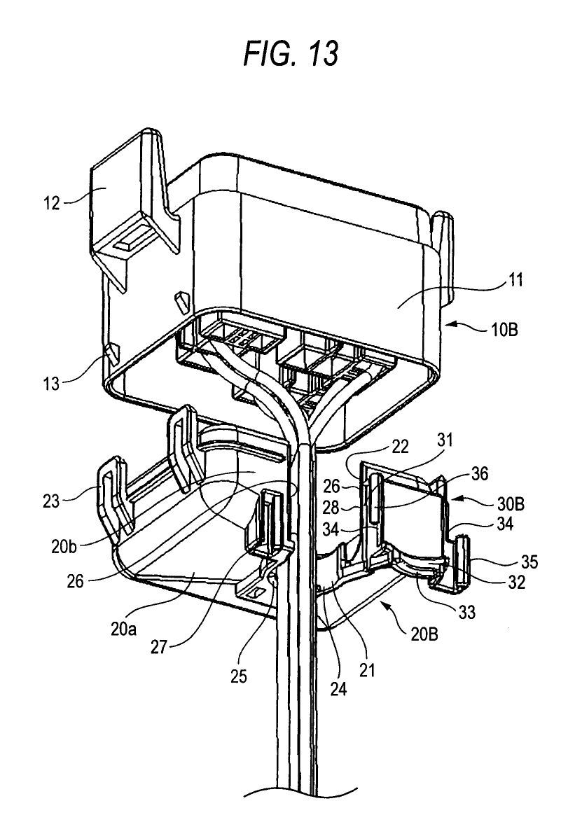

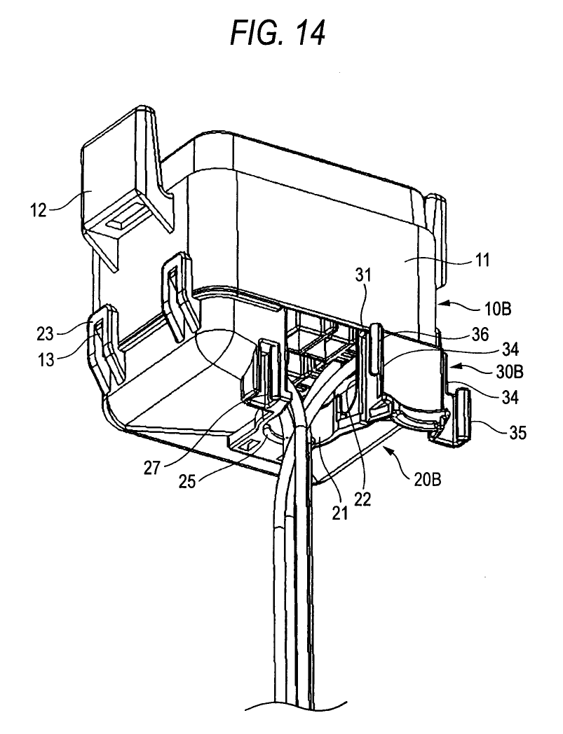

In this case, also, when assembling the electric connection box, the lower cover 20B is attached to a lower side of the connection box body 10B as shown in FIGS. 13 and 14. At this time, wires W are inserted into a first notch 21 from the second notch 22. At this stage, the lid 30B is held in the open (right) position so as not to interfere with the operation for attaching the lower cover 20B.

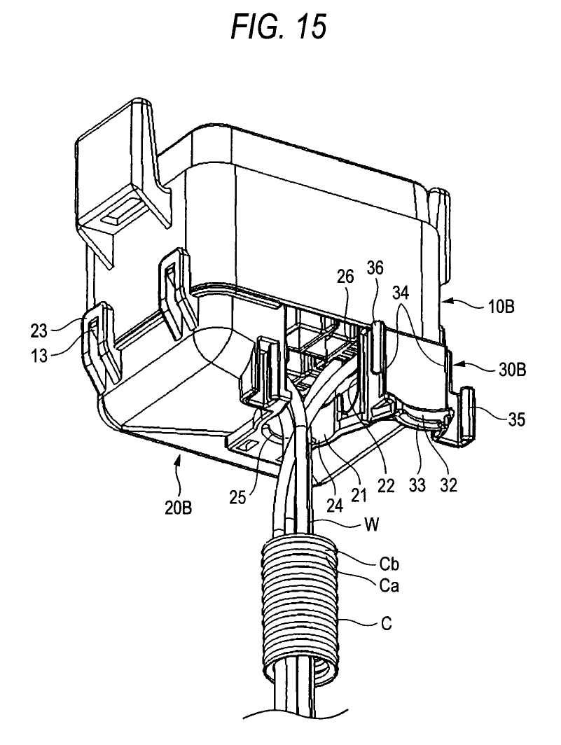

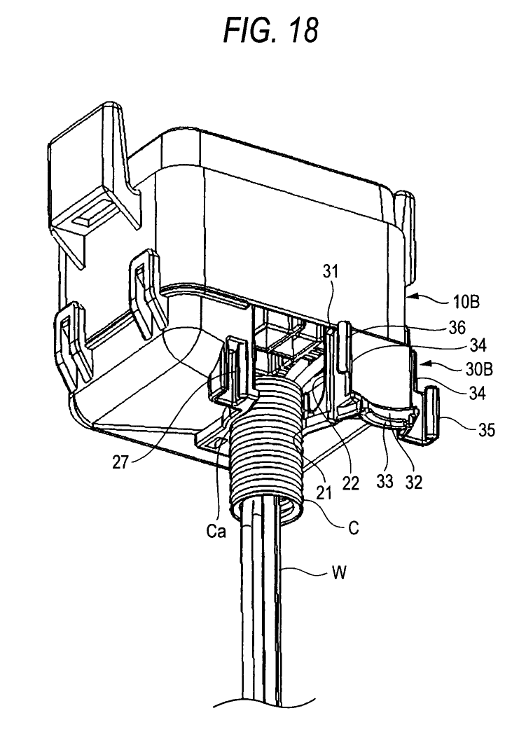

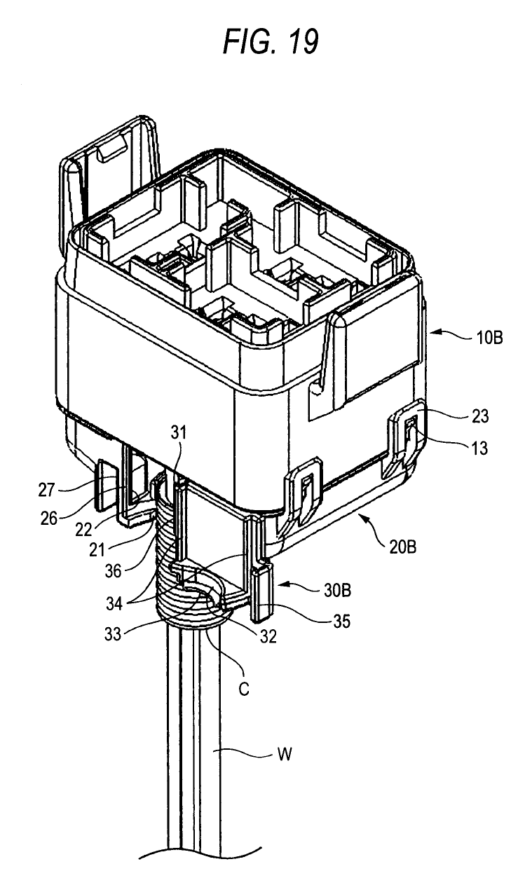

Then, a corrugated tube C is fitted on the wires W as shown in FIGS. 15, 16 and 17, and the position of the corrugated tube C is adjusted, and a fixing portion of the corrugated tube C is located at a ridge 25 (see FIG. 15) of the first notch 21 as shown in FIGS. 18 and 19.

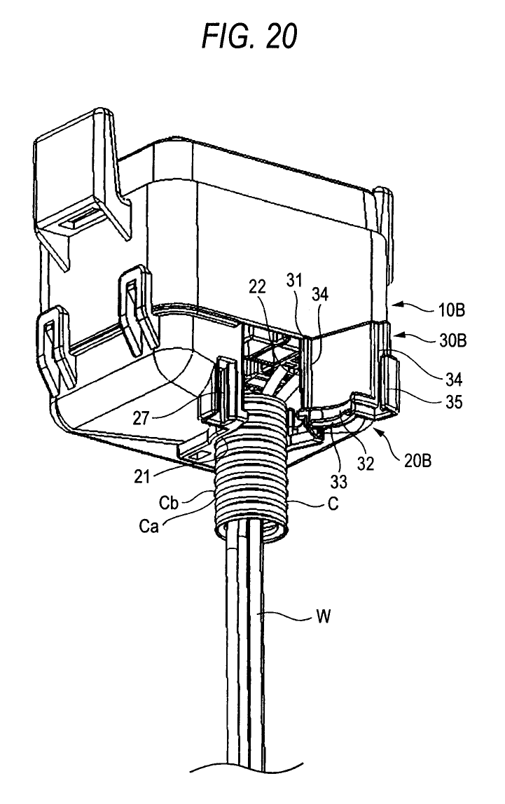

In this condition, the lid 30B is closed as shown in FIGS. 20 to 23. As a result, ridges 25 and 33 formed respectively on inner surfaces of peripheral walls 24 and 32 formed respectively at the lower cover 20B and the lid 30B are fitted in an annular concave portion Ca in the outer periphery of the corrugated tube C, thereby positioning and fixing this wire protection tube C.

Thus, after the lower cover 20B is attached to the connection box body 106, the position of the corrugated tube C is adjusted, and then the lid 30B is closed, and by doing so, the corrugated tube C can be positioned and fixed. Therefore, the assembling operation can be easily carried out. Furthermore, merely by opening the lid 30B with the lower cover 20B kept attached to the connection box body 10B, the fixing of the corrugated tube C is canceled, and therefore the disassembling operation can also be easily carried out, and besides the position of the corrugated tube C can again be easily adjusted.

Furthermore, when the lid 30B is closed, abutment walls 26 and 34 abut against each other, and also engagement portions 35 and 35 are engaged respectively with engagement portions 27 and 28, and therefore a sealing effect can be secured, and besides the lid 30B can be positively fixed without shaking.

Furthermore, in this embodiment, the lid 30B is molded integrally with the lower cover 20B through the hinge 31, and therefore the number of the component parts can be reduced, and besides merely by pivotally moving the lid 30B through the hinge 31, the lid 30B can be easily closed into the proper position, and the efficiency of the assembling operation can be enhanced. Furthermore, by thus molding the lid 30B integrally with the lower cover 20B, the construction of the connection box body 10B can be simplified.

The present invention is not limited to the above embodiments, and suitable modifications, improvements, etc., can be made. Furthermore, the material, shape, dimensions, number, disposition, etc., of each of the constituent elements of the above embodiments are arbitrary, and are not limited in so far as the invention can be achieved.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2006-235758 filed on Aug. 31, 2006, the contents of which are incorporated herein for reference.

What is claimed is:

1. An electric connection box, comprising:
a main body for receiving a parts to be connected to a wire;
a lower cover which is attached to the main body to cover a lower face of the main body;
a first notch for leading out the wire which is formed in the lower cover;
a second notch which is formed in the lower cover in continuous with the first notch for inserting the wire into the first notch from a side of the lower cover through the second notch;
a lid which opens and closes the second notch;
peripheral walls which are formed respectively at the lower cover and the lid, and define the first notch as an opening when the lid is closed; and
ridge portions which are formed respectively on inner surfaces of the peripheral walls of the lower cover and the lid, and are fitted in an annular concave portion in an outer periphery of a wire protection tube fitted on the wire led out through the first notch when the lid is closed.

2. The electric connection box according to claim 1, wherein the main body, the lower cover and the lid are resin-molded products, and the lid is molded integrally with one of the main body and the lower cover through a hinge portion so as to be pivotally moved

3. The electric connection box according to claim 2, wherein the lid is pivotally connected to a lower edge of an outer wall of the main body through the hinge portion so as to be pivotally moved upward and downward.

4. The electric connection box according to claim 2, wherein the lid is pivotally connected to a side edge of the second notch in the lower cover so as to be pivotally moved right and left.

5. The electric connection box according to claim 1, wherein abutment walls are formed respectively at peripheral edges of the second notch and the lid to abut against each other so as to close a gap between the second notch and the lid when the lid is closed; and
wherein engagement portions are formed respectively at the tower cover and the lid, and are engaged with each other so that the lower cover is locked with the lid when the lid is closed.
